(19) United States
(12) Patent Application Publication
(10) Pub. No.: US 2017/0344539 A1
(43) Pub. Date: Nov. 30, 2017

(54) SYSTEM AND METHOD FOR IMPROVED SCALABILITY OF DATABASE EXPORTS

(71) Applicant: SPOTIFY AB, Stockholm (SE)

(72) Inventors: Radovan Zvoncek, Stockholm (SE); Marco Siebecke, Stockholm (SE); Björn Hegerfors, Stockholm (SE); Emilio Del Tessandoro, Stockholm (SE); Malcolm Matalka, Stockholm (SE)

(21) Appl. No.: 15/604,388

(22) Filed: May 24, 2017

Related U.S. Application Data
(60) Provisional application No. 62/340,970, filed on May 24, 2016.

(51) Int. Cl. G06F 17/30; G06F 9/50

(52) U.S. Cl. CPC G06F 17/303; G06F 17/30864; G06F 9/5088; G06F 17/30005

(57) ABSTRACT

In accordance with an embodiment, described herein is a system and method for providing improved scalability of database exports, for use in digital media content or other environments. Data can be stored within and/or provided by an environment which supports the use of persistent disks. By cloning the persistent disks; spawning a plurality of small clusters and exposing only part of the data to each small cluster for processing; and, automatically converting rows of data to records; the exporting of the data can be performed in a trivially-parallelized manner, since it uses an arbitrary number of workers who are not required to communicate with one other. The results of the data export can be written to a cloud storage, or to another storage environment; and, where appropriate for the benefit of subsequent data analysis, converted to, for example, an Avro format.

### CLAIM OF PRIORITY

This application claims the benefit of priority to U.S. Provisional Patent Application titled “SYSTEM AND METHOD FOR IMPROVED SCALABILITY OF DATABASE EXPORTS”, Application No. 62/340,970, filed May 24, 2016, which application is herein incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF INVENTION

Embodiments of the invention are generally related to data processing, and digital media content environments, and are particularly related to systems and methods for providing improved scalability of database exports, for use in these or other environments.

### BACKGROUND

Today's consumers enjoy the ability to access a tremendous amount of media content, such as music and videos, using a wide variety of media devices. Digital media content environments, for example those provided by media streaming services such as Spotify, are ideally suited to delivering media content to users in a way that addresses the individual preferences of each user. However, to accomplish this, the data processing environment must be able to process large amounts of data, including database exports, in a computationally-efficient manner. These are some examples of the types of environments in which embodiments of the invention can be used.

### SUMMARY

In accordance with an embodiment, described herein is a system and method for providing improved scalability of database exports, for use in digital media content or other environments. Data can be stored within and/or provided by an environment which supports the use of persistent disks. By cloning the persistent disks; spawning a plurality of small clusters and exposing only part of the data to each small cluster for processing; and, automatically converting rows of data to records; the exporting of the data can be performed in a trivially-parallelized manner, since it uses an arbitrary number of workers who are not required to communicate with one other. The results of the data export can be written to a cloud storage, or to another storage environment; and, where appropriate for the benefit of subsequent data analysis, converted to, for example, an Avro format.

### BRIEF DESCRIPTION OF THE FIGURES

FIG. 1 illustrates an exemplary digital media content environment, in accordance with an embodiment.

FIG. 2 illustrates a database export environment, in accordance with an embodiment.

FIG. 3 further illustrates a database export environment, in accordance with an embodiment.

FIG. 4 further illustrates a database export environment, in accordance with an embodiment.

FIG. 5 further illustrates a database export environment, in accordance with an embodiment.

FIG. 6 further illustrates a database export environment, in accordance with an embodiment.

FIG. 7 further illustrates a database export environment, in accordance with an embodiment.

FIG. 8 further illustrates a database export environment, in accordance with an embodiment.

FIG. 9 further illustrates a database export environment, in accordance with an embodiment.

FIG. 10 illustrates a database export process, in accordance with an embodiment.

### DETAILED DESCRIPTION

As described above, digital media content environments, for example those provided by media streaming services such as Spotify, are ideally suited to delivering media content to users in a way that addresses the individual preferences of each user. However, to accomplish this, the data processing environment must be able to process large amounts of data, including database exports, in a computationally-efficient manner.

In accordance with an embodiment, described herein is a system and method for providing improved scalability of database exports, for use in digital media content or other environments. Data can be stored within and/or provided by an environment which supports the use of persistent disks. By cloning the persistent disks; spawning a plurality of small clusters and exposing only part of the data to each small cluster for processing; and, automatically converting rows of data to records; the exporting of the data can be performed in a trivially-parallelized manner, since it uses an arbitrary number of workers who are not required to communicate with one other.

The results of the data export can be written to a cloud storage, or to another storage environment; and, where appropriate for the benefit of subsequent data analysis, converted to, for example, an Avro format.

### Database Exports

Generally, when exporting data from any type of database, certain characteristics of the database export are desired.

For example, it should be possible to provide information such as “This is how my database looked like at time X”. The database export should be timely, since such exports tends to be the first step in a data pipeline, and generally the sooner it can be completed, the better. The export process should impact the data source as little as possible, to reduce the possibility of a denial-of-service. Finally, it is beneficial to obtain insights into the export process, for example to answer questions such as “This is how many records came out of the database”.

Data processing environments which need to process large amounts of data can use technologies such as Hadoop, with the data sets required for data pipelines being stored, for example, in a Cassandra or other type of database that supports access from Hadoop.

One approach to performing database exports in such an environment, is to copy Sorted Strings Tables (SSTables) from Cassandra nodes, to the Hadoop framework, and to run a compaction implemented as a MapReduce job.

The advantages of this approach include negligible impact to the Cassandra cluster; scalability of the compaction step; incremental operation; and acceptable end-to-end latency. However, these advantages are somewhat offset by the need to provide custom code to parse the Cassandra files, and difficulties due to SSTable format changes between different Cassandra versions and data schemas.

The above-described approach can be used to ship data from Hadoop, and perform a user-supplied conversion to Avro records, within a timeframe time that reduces the previous 24 hours or greater export time, to approximately 4 hours. However, since the databases used in a data processing environment generally evolve over time, problems can arise due to, for example, the need to maintain the custom code.

Furthermore, as the data volume increases, the time required for shipping the data takes increasingly longer.

### Digital Media Content Environments

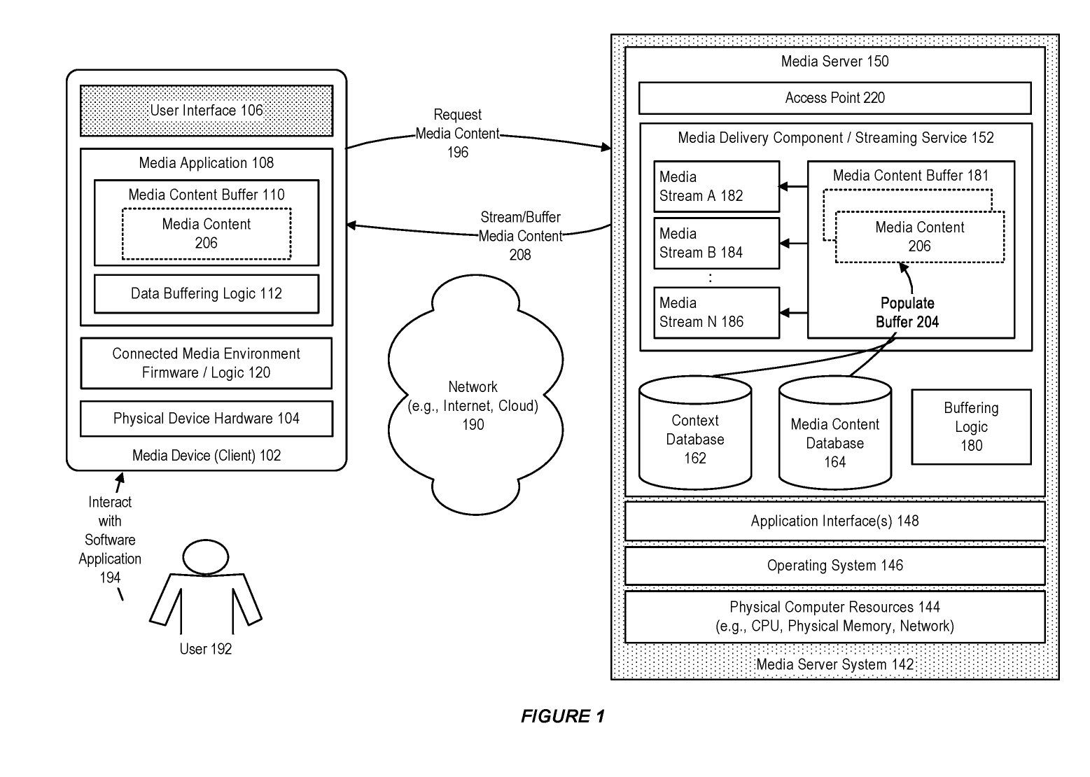

FIG. 1 illustrates an exemplary digital media content environment, in accordance with an embodiment, which can benefit from the systems and methods for providing improved scalability of database exports, as described herein.

As illustrated in FIG. 1, in accordance with an embodiment, a media device 102, operating as a client device, can receive and play media content provided by a media server system 142 (media server), or by another system or peer device. In accordance with an embodiment, the media device can be, for example, a personal computer system, handheld entertainment device, tablet device, smartphone, television, audio speaker, in-car entertainment system, or other type of electronic or media device that is adapted or able to prepare a media content for presentation, control the presentation of media content, and/or play or otherwise present media content.

In accordance with an embodiment, each of the media device and the media server can include, respectively, one or more physical device or computer hardware resources 104, 144, such as one or more processors (CPU), physical memory, network components, or other types of hardware resources.

In accordance with an embodiment, the media device can optionally include a touch-enabled or other type of display screen having a user interface 106, which is adapted to display media options, for example as an array of media tiles, thumbnails, or other format, and to determine a user interaction or input. Selecting a particular media option, for example a particular media tile or thumbnail, can be used as a command by a user and/or the media device, to the media server, to download advertisement, stream or otherwise access a corresponding particular media content item or stream of media content.

In accordance with an embodiment, the media device can also include a software media application 108, together with an in-memory client-side media content buffer 110, and a data buffering logic or software component 112, which can be used to control the playback of media content received from the media server, for playing either at a requesting media device (i.e., controlling device) or at a controlled media device (i.e., controlled device), in the manner of a remote control. A connected media environment firmware, logic or software component 120 enables the media devices to participate within a connected media environment.

In accordance with an embodiment, the media server can include an operating system 146 or other processing environment which supports execution of a media server 150 that can be used, for example, to stream music, video, or other forms of media content to a client media device, or to a controlled device.

In accordance with an embodiment, one or more application interface(s) 148 can receive requests from client media devices, or from other systems, to retrieve media content from the media server. A context database 162 can store data associated with the presentation of media content by a client media device, including, for example, a current position within a media stream that is being presented by the media device, or a playlist associated with the media stream, or one or more previously-indicated user playback preferences. The media server can transmit context information associated with a media stream to a media device that is presenting that stream, so that the context information can be used by the device, and/or displayed to the user. The context database can be used to store a media device's current media state at the media server, and synchronize that state between devices, in a cloud-like manner. Alternatively, media state can be shared in a peer-to-peer manner, wherein each device is aware of its own current media state which is then synchronized with other devices as needed.

In accordance with an embodiment, a media content database 164 can include media content, for example music, songs, videos, movies, or other media content, together with metadata describing that media content. The metadata can be used to enable users and client media devices to search within repositories of media content, to locate particular media content items.

In accordance with an embodiment, a buffering logic or software component 180 can be used to retrieve or otherwise access media content items, in response to requests from client media devices or other systems, and to populate a server-side media content buffer 181, at a media delivery component or streaming service 152, with streams 182, 184, 186 of corresponding media content data, which can then be returned to the requesting device or to a controlled device.

In accordance with an embodiment, a plurality of client media devices, media server systems, and/or controlled devices, can communicate with one another using a network, for example the Internet 190, a local area network, peer-to-peer connection, wireless or cellular network, or other form of network. For example, a user 192 can interact 194 with the user interface at a client media device, and issue requests to access media content, for example the playing of a selected music or video item at their device, or at a controlled device, or the streaming of a media channel or video stream to their device, or to a controlled device.

In accordance with an embodiment, the user's selection of a particular media option can be communicated 196 to the media server, via the server's application interface. The media server can populate its media content buffer at the server 204, with corresponding media content, 206 including one or more streams of media content data, and can then communicate 208 the selected media content to the user's media device, or to a controlled device as appropriate, where it can be buffered in a media content buffer for playing at the device.

In accordance with an embodiment, and as further described below, the system can include a server-side media gateway or access point 220, or other process or component, which operates as a load balancer in providing access to one or more servers, for use in processing requests at those servers. The system can enable communication between a client media device and a server, via an access point at the server, and optionally the use of one or more routers, to allow requests from the client media device to be processed either at that server and/or at other servers.

For example, in a Spotify media content environment, Spotify clients operating on media devices can connect to various Spotify back-end processes via a Spotify “accesspoint”, which forwards client requests to other servers, such as sending one or more metadata proxy requests to one of several metadata proxy machines, on behalf of the client or end user.

Database Exports for Use with Media Content and Other Environments

Cloud-based data processing environments, such as Google Cloud, can be utilized with digital media content or other environments, for example to enable a media content playlist to be stored in a cluster, and examined to determine useful analytics.

Generally, a data analyst cannot simply retrieve all of the current data at once, since this might cause the playlist feature to stop working. Instead, the data is typically copied from the cluster, and analytical computations performed on the copy of the data.

Technologies such as persistent disks (PD), for example as supported by Google Cloud, allow for efficient copying or cloning, by providing a decoupling of storage from computation, and support for differential snapshotting.

At a particular point in time, an image of a persistent disk can be performed quickly, since only dirty blocks need be considered. Persistent disks can also be attached to many machines. Together, these functionalities allows for rapid cloning and attaching of a clone to many machines.

For example, such a system allows for creating 100 smaller clusters of 1-node each, and attaching persistent disks to each of them; and then allowing each smaller cluster see only part of the data.

In accordance with an embodiment, by cloning the persistent disks; spawning several small clusters, and exposing only part of the data to each cluster for processing; and, automatically converting the rows of data to records; the process of exporting the data can be performed in a trivially-parallelized manner, since it uses an arbitrary number of workers who are not required to communicate with one other.

In accordance with an embodiment, the results of the data export can then be written to a cloud storage, or to another storage environment; and, where appropriate for the benefit of subsequent data analysis, converted to, for example, an Avro format.

### Example Database Export Process

In accordance with an example embodiment, which utilizes Google Cloud and which supports the above-described approach, given, for example, a Cassandra cluster with a data center in the Google Cloud Platform (GCP), a snapshot of the data can be made at a particular time, represented as Cassandra Query Language (CQL) rows, and then made available, for example, in Google Cloud Storage (GCS), as Avro records.

In accordance with an embodiment, the process uses persistent disk snapshots to create read-only copies or clones of the production disks, mount these copies to many 1-node Cassandra clusters, instruct each cluster to run a SELECT query for a small token range, and write the retrieved data, for example, to GCS as Avro records. Since, in this example, the Cassandra cluster has its data center in a GCP zone, this approach can be used to provide all of the data that is made available within the Google infrastructure.

In accordance with an embodiment, for each Cassandra data file, a determination is made as to the keys it contains, and which information is used to group SSTables, so that each of the M×1-node clusters will receive access to all of the SSTables containing data in the token range it will later query.

In accordance with an embodiment, the grouping can also consider SSTable sizes, for better load balancing.

More formally, this mapping can be expressed as:

[hostname]->[(sstable,size,range)]->[(hostname,[sstable])]

In accordance with an embodiment, the Cassandra cluster can be spawned as standalone, e.g., virtual machines (VM), or Docker images, which are parameterized with which of the persistent disks to mount, and the token range that will be queried.

In accordance with an embodiment, Cassandra instances can be tuned, for example, for read-only workload, or to disable features that are not needed (e.g., compactions).

Then, each of the 1-node clusters runs its SELECT query autonomously and asynchronously. This query yields a list of CQL rows (as defined by the Cassandra Java-driver), which are converted to, for example, Avro records, and written to the output location, for example, to GCS, Bigtable, or to a backup or other type of storage.

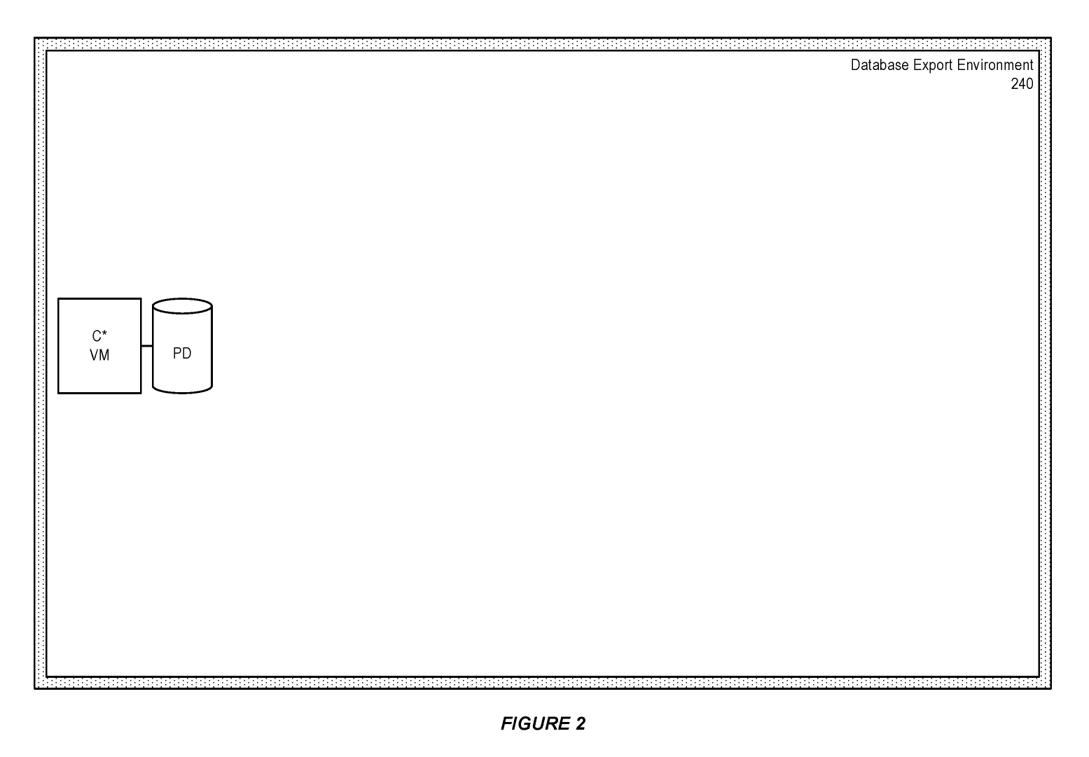

FIGS. 2-9 illustrate a database export environment 240, in accordance with an embodiment, as can be used, for example, with playlist data or other types of data used within a digital media content environment.

As illustrated in FIG. 2, in accordance with an embodiment, the system can include one or more, e.g., Cassandra (C*), nodes containing production data, transparently shipping the data to persistent disks. As described above, the disks can be cloned quickly, and can be attached to many machines, which can also be spawned.

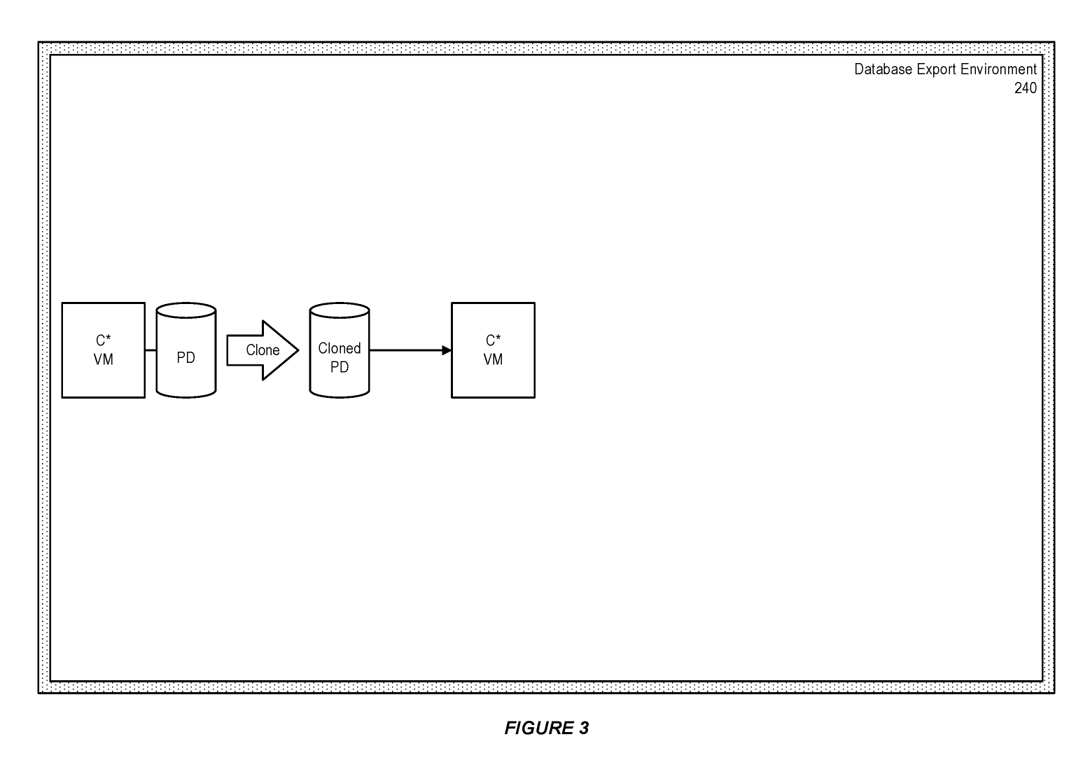

As illustrated in FIG. 3, in accordance with an embodiment, the persistent disk can be cloned and attached to another, e.g., Cassandra, machine, which can be configured similarly to the production machine, and which similarly allows query of the data.

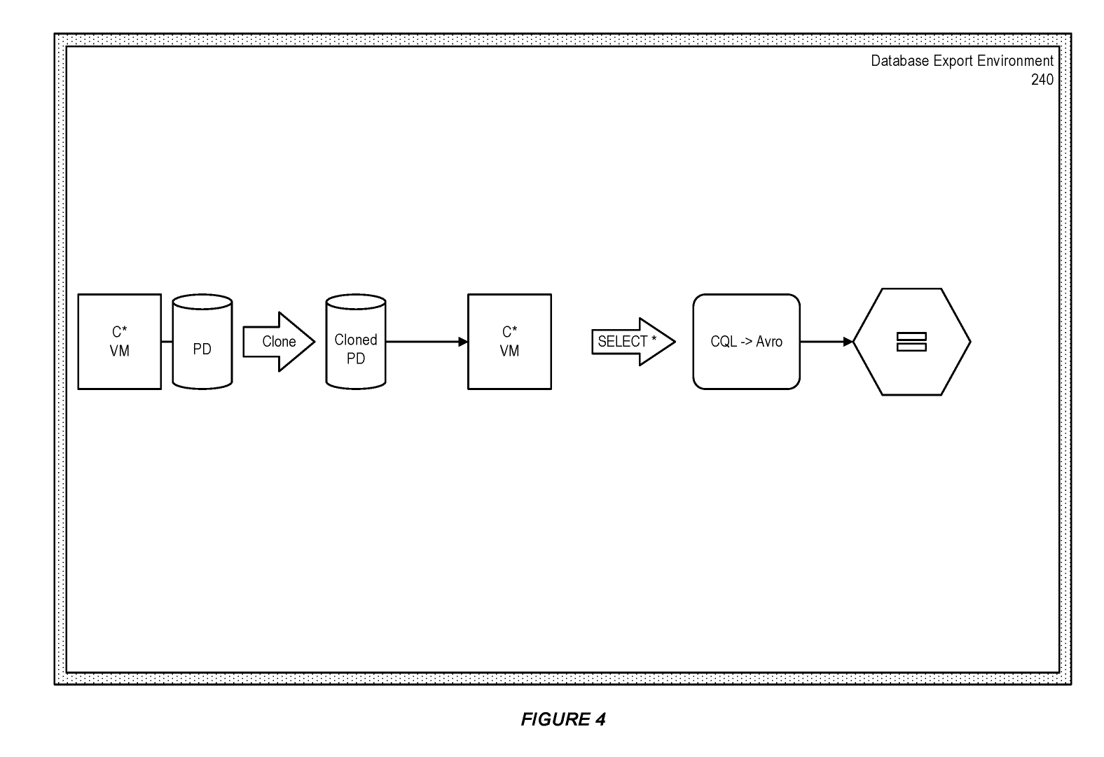

As illustrated in FIG. 4, in accordance with an embodiment, a SELECT * statement can be used to return rows in, e.g., Cassandra, which can then be converted into a format, e.g., Avro, that may be used by a data analyst.

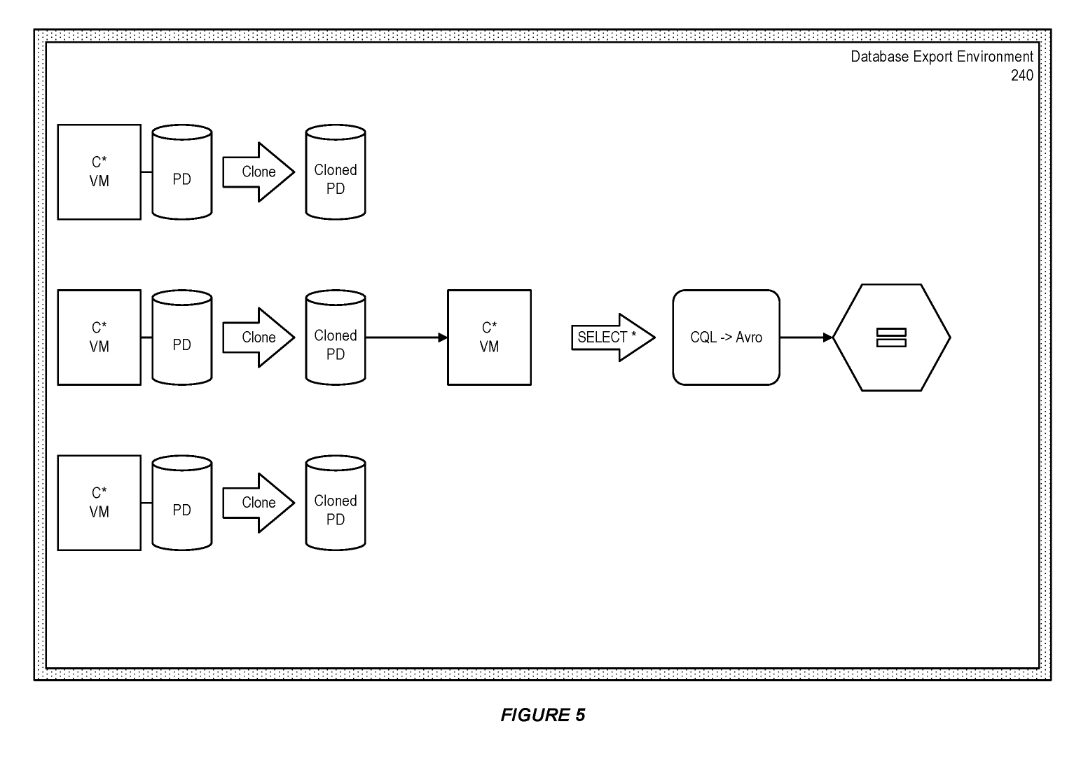

As illustrated in FIG. 5, in accordance with an embodiment, since, in a production environment, each production, e.g., Cassandra, cluster generally has more than one node, the persistent disk functionality can be used to clone disks in parallel. Additionally, since having a large number of disks might be too much for a single, e.g., Cassandra node, additional VMs can be spawned.

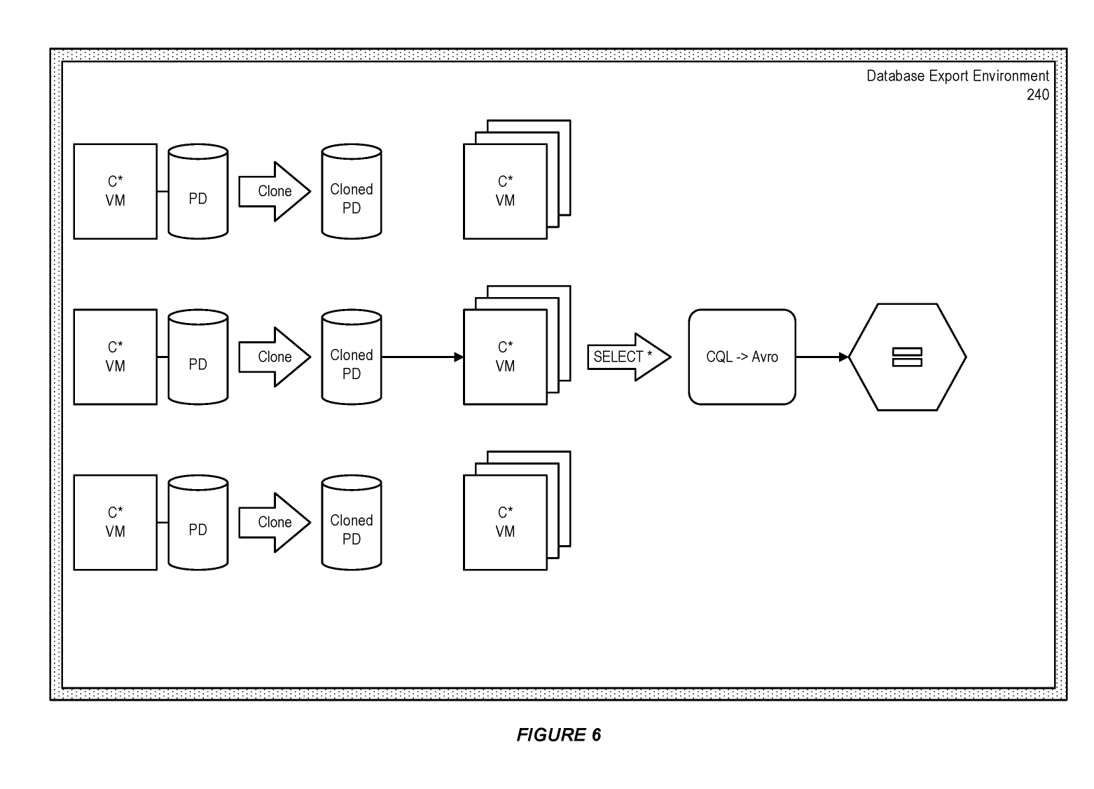

As illustrated in FIG. 6, in accordance with an embodiment, with many machines available, the data can be partitioned, and each node instructed to process only one chunk of the data. Using the above approach, the system can determine which particular data each node needs to see, and which persistent disks this particular set of data resides on.

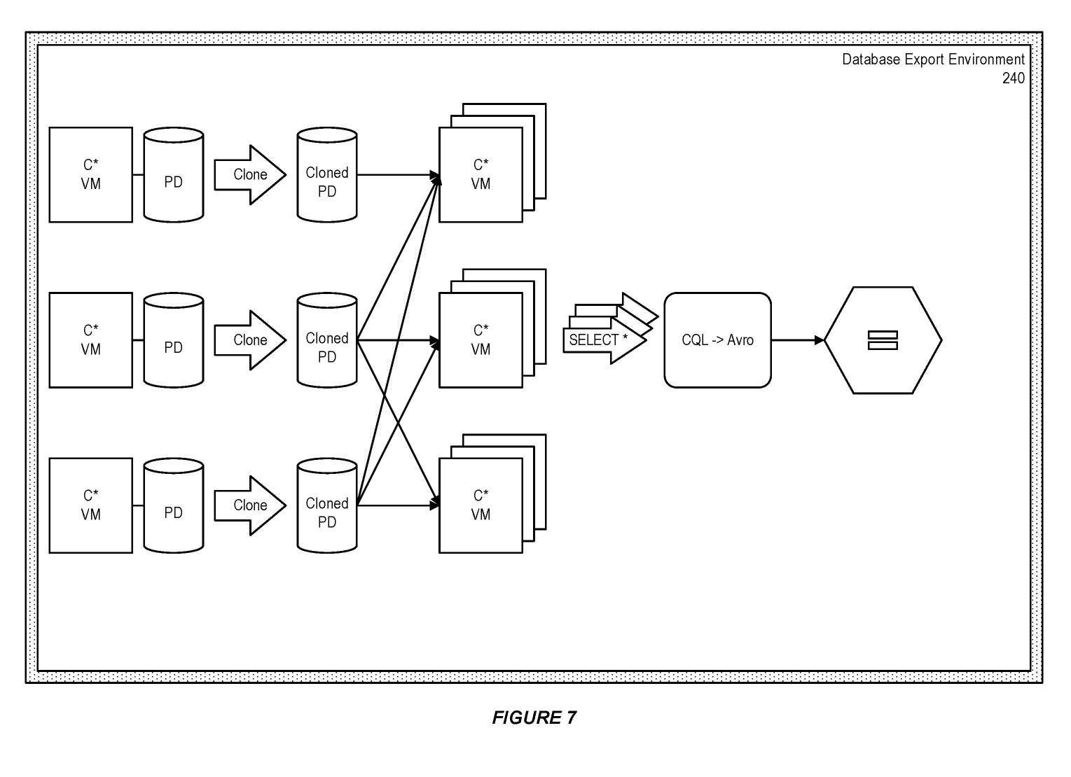

As illustrated in FIG. 7, in accordance with an embodiment, each disk is attached to only a few, generally not all, virtual machines. Since each node sees all of the data it should (which might be data from multiple source nodes), there is no need to organize the worker nodes into a cluster. Instead, they can be simply left as 1-node clusters, which simplifies things, and saves node resources.

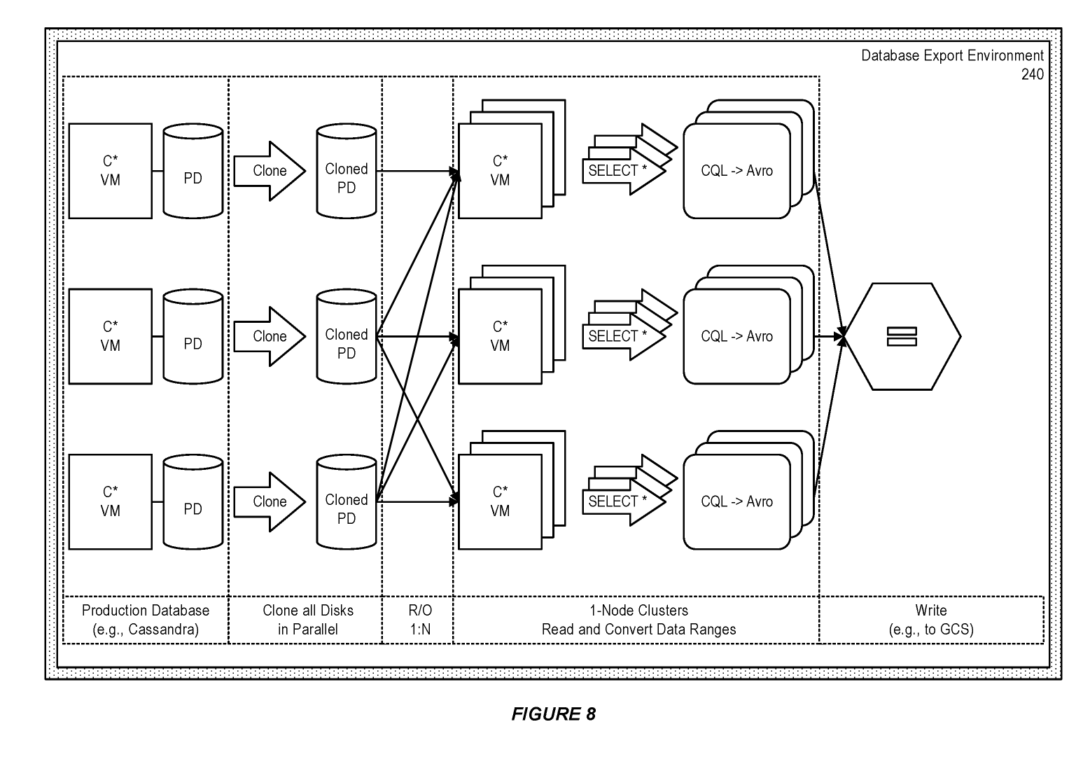

As illustrated in FIG. 8, in accordance with an embodiment, all of the 1-node clusters can then run their small SELECTs, and consequent conversions, in parallel.

Importantly, having independent workers who do not communicate with each other, and share no state, permits the trivially-parallelizable setup, which in turn provides the advantage in that independent workers scale linearly.

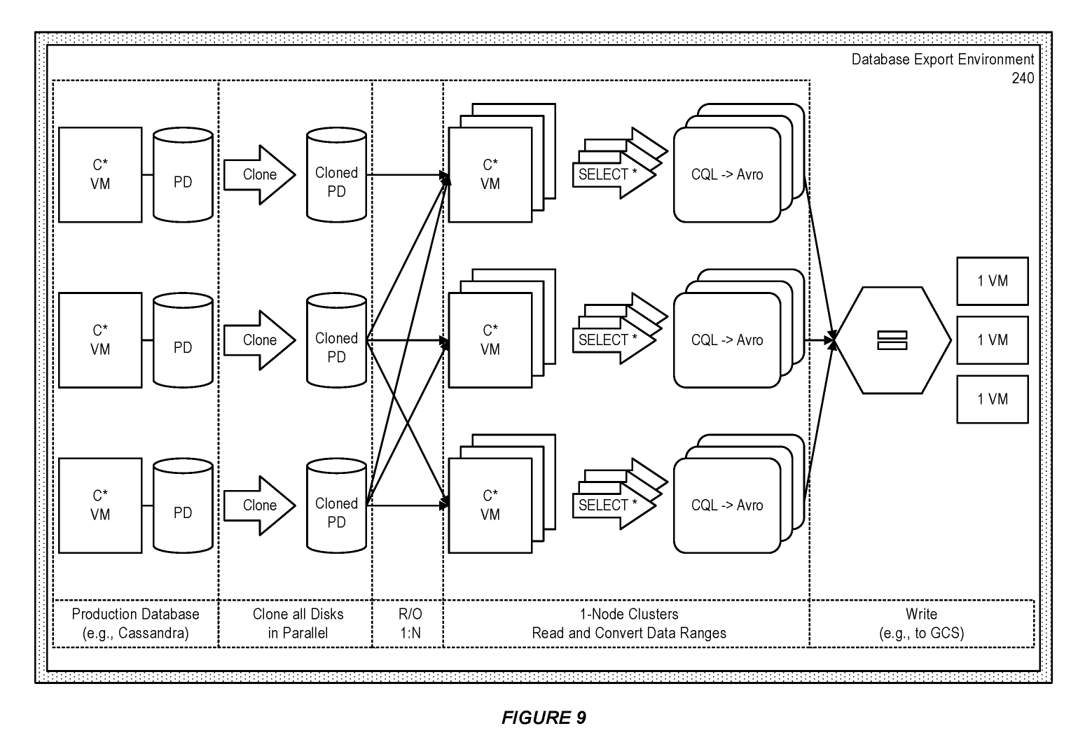

As illustrated in FIG. 9, in accordance with an embodiment, as an additional benefit, the system can co-locate multiple workers on a single virtual machine, to better utilize resources.

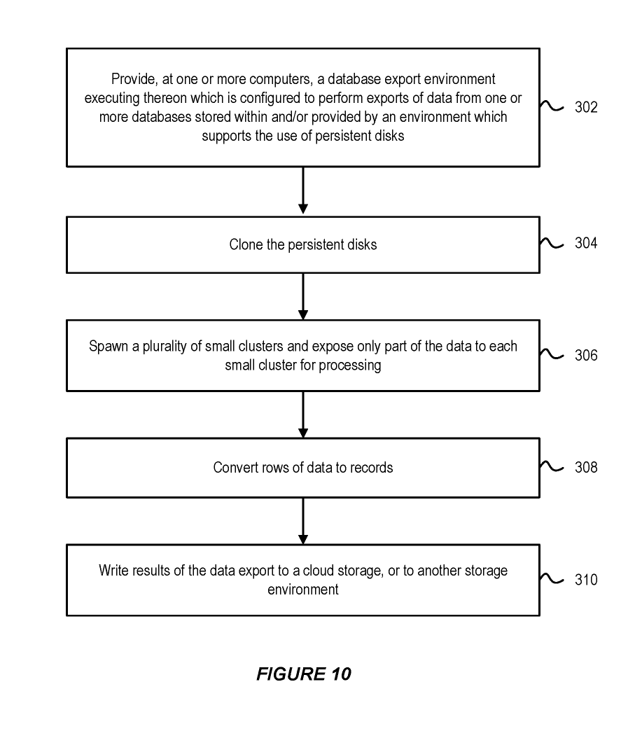

FIG. 10 illustrates a database export process, in accordance with an embodiment.

As illustrated in FIG. 10, in accordance with an embodiment, at step 302, at one or more computers, a database export environment is provided executing thereon which is configured to perform exports of data from one or more databases stored within and/or provided by an environment which supports the use of persistent disks.

At step 304, the persistent disks are cloned.

At step 306, a plurality of small clusters are spawned, and only part of the data is exposed to each small cluster for processing.

At step 308, rows of data are converted to records.

At step 310, the results of the data export are written to a cloud storage, or to another storage environment.

Embodiments of the present invention may be conveniently implemented using one or more conventional general purpose or specialized digital computer, computing device, machine, or microprocessor, including one or more processors, memory and/or computer readable storage media programmed according to the teachings of the present disclosure. Appropriate software coding can readily be prepared by skilled programmers based on the teachings of the present disclosure, as will be apparent to those skilled in the software art.

In some embodiments, the present invention includes a computer program product which is a non-transitory computer readable storage medium (media) having instructions stored thereon/in which can be used to program a computer to perform any of the processes of the present invention. Examples of storage mediums can include, but are not limited to, floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or other types of storage media or devices suitable for non-transitory storage of instructions and/or data.

The foregoing description of embodiments of the present invention has been provided for the purposes of illustration and description. It is not intended to be exhaustive or to limit the invention to the precise forms disclosed. Many modifications and variations will be apparent to the practitioner skilled in the art.

For example, while the techniques described above generally describe usage with digital media content environments, and Cassandra databases, the systems and methods providing improved scalability of database exports, as described herein, can be similarly used with other types of computing environments, and other types of data or databases.

The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalents.

What is claimed is:

1. A system that provides improved scalability of database exports, comprising
one or more computers, including a database export environment executing thereon which is configured to perform a data export from one or more databases stored within and/or provided by an environment which supports the use of persistent disks, including
cloning the persistent disks,
spawning a plurality of clusters and exposing part of the data to each cluster for processing, and
converting rows of data to records; and
wherein results of the data export are written to a cloud storage, or to another storage environment.

2. The system of claim 1, wherein each of the clusters runs a SELECT query on the part of the data exposed to that cluster for processing.

3. The system of claim 1, wherein the process of exporting the data is performed in a trivially-parallelized manner.

4. The system of claim 1, wherein the results of the data export are converted to an Avro or other data analysis format.

5. The system of claim 1, wherein the system is used with a digital media content environment to provide export of data associated with the digital media content environment.

6. The system of claim 5, wherein the data is playlist data that is associated with the digital media content environment and maintains a playlist functionality usable by one or more media servers and media devices, and wherein the playlist data describes at least one of contents of one or more playlists, or usage of the playlist functionality.

7. A method of providing improved scalability of database exports, comprising:
providing, at one or more computers, a database export environment executing thereon which is configured to perform a data export from one or more databases stored within and/or provided by an environment which supports the use of persistent disks, including
cloning the persistent disks,
spawning a plurality of clusters and exposing part of the data to each cluster for processing, and
converting rows of data to records; and
writing results of the data export to a cloud storage, or to another storage environment.

8. The method of claim 7, wherein each of the clusters runs a SELECT query on the part of the data exposed to that cluster for processing.

9. The method of claim 7, wherein the process of exporting the data is performed in a trivially-parallelized manner.

10. The method of claim 7, wherein the results of the data export are converted to an Avro or other data analysis format.

11. The method of claim 7, wherein the method is used with a digital media content environment to provide export of data associated with the digital media content environment.

12. The method of claim 11, wherein the data is playlist data that is associated with the digital media content environment and maintains a playlist functionality usable by one or more media servers and media devices, and wherein the playlist data describes at least one of contents of one or more playlists, or usage of the playlist functionality.

13. A non-transitory computer readable storage medium, including instructions stored thereon which when read and executed by one or more computers cause the one or more computers to perform the steps comprising:
providing, at one or more computers, a database export environment executing thereon which is configured to perform a data export from one or more databases stored within and/or provided by an environment which supports the use of persistent disks, including
cloning the persistent disks,
spawning a plurality of clusters and exposing part of the data to each cluster for processing, and
converting rows of data to records; and
writing results of the data export to a cloud storage, or to another storage environment.

14. The non-transitory computer readable storage medium of claim 13, wherein each of the clusters runs a SELECT query on the part of the data exposed to that cluster for processing.

15. The non-transitory computer readable storage medium of claim 13, wherein the process of exporting the data is performed in a trivially-parallelized manner.

16. The non-transitory computer readable storage medium of claim 13, wherein the results of the data export are converted to an Avro or other data analysis format.

17. The non-transitory computer readable storage medium of claim 13, wherein the steps are used with a digital media content environment to provide export of data associated with the digital media content environment.

18. The non-transitory computer readable storage medium of claim 17, wherein the data is playlist data that is associated with the digital media content environment and maintains a playlist functionality usable by one or more media servers and media devices, and wherein the playlist data describes at least one of contents of one or more playlists, or usage of the playlist functionality.
